(19) United States
(12) Patent Application Publication
(10) Pub. No.: US 2013/0051615 A1
(43) Pub. Date: Feb. 28, 2013

(54) APPARATUS AND METHOD FOR PROVIDING APPLICATIONS ALONG WITH AUGMENTED REALITY DATA

(71) Applicants: Sang-Hyeok LIM, Incheon-si (KR); Gum-Ho KIM, Seoul (KR); Yu-Seung KIM, Seoul (KR)

(72) Inventors: Sang-Hyeok LIM, Incheon-si (KR); Gum-Ho KIM, Seoul (KR); Yu-Seung KIM, Seoul (KR)

(73) Assignee: PANTECH CO., LTD., Seoul (KR)

(21) Appl. No.: 13/336,748

(22) Filed: Dec. 23, 2011

(30) Foreign Application Priority Data
Aug. 24, 2011 (KR) 10-2011-0084792

(51) Int. Cl. G06K 9/00

(52) U.S. Cl. 382/103

(57) ABSTRACT

A mobile terminal to execute an application, the application being retrieved by a search term generated from augmented reality data, and a method thereof is provided. A method for filtering, determining and displaying the applications as icons on a mobile terminal is also provided. A method for displaying and providing access for retrieving applications is also provided.

### CROSS-REFERENCE TO RELATED APPLICATION

This application claims priority from and the benefit under 35 U.S.C. §119(a) of Korean Patent Application No. 10-2011-0084792, filed on Aug. 24, 2011, which is incorporate by reference for all purposes as if fully set forth herein.

### BACKGROUND

1. Field

The disclosure relates to augmented reality, and more particularly to, an apparatus and method for providing an application using augmented reality data.

2. Discussion of the Background

Augmented reality (AR) describes a capability of recognizing a general position by use of position and direction information, and recognizing a service by comparing surrounding environment information, such as details of nearby facilities. In order to accomplish this, AR uses actual image information input along with the movement of a camera that takes images of a nearby surrounding, which is used to provide AR. Thus, AR represents a computer graphic scheme that combines a virtual object or information with an image of a real-world environment. Unlike virtual reality, which displays merely a virtual space and a virtual substance as an object, AR provides additional information, which may not be easily obtained in the real world, by adding a virtual object to an image or display of a real world. Recently, AR has been implemented along with mobile devices.

However, if a user requires AR information related to a reference object, an application or information related to the reference object is installed in advance to provide the AR information. In addition, a content provider may provide the information for AR if the information is stored in database. Thus, the AR information is limited by that which is provided by the content provider.

### SUMMARY

The present disclosure is directed to providing an apparatus and method in which AR information related an object is analyzed and an application using the analyzed information is recommended and/or provided, in addition, the analyzed information is automatically applied to the recommended/provided application if the application is executed.

Additional features of the invention will be set forth in the description which follows, and in part will be apparent from the description, or may be learned by practice of the invention.

An exemplary embodiment provides a mobile terminal, including an image acquisition unit to acquire an image of a real-world environment; an object recognition unit to recognize an object from the image; an object analysis unit to analyze tag information associated with the object; a search term generating unit to determine a search term based on the tag information, wherein the search term is utilized to determine an application for the mobile terminal, and the application utilizes the tag information in response to the application being executed.

An exemplary embodiment provides a method for providing an application based on augmented reality, including: acquiring an image of a real-world environment; recognizing an object from the image; analyzing tag information associated with the object; determining a search term based on the tag information; determining the application for the mobile terminal based on the search term; and utilizing the tag information in response to the application being executed.

An exemplary embodiment provides a server to provide an application based on augmented reality, including a communication unit to receive augmented reality data and transmit the application to an external device; and an application search unit to determine the application based on the augmented reality data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a terminal and a server according to an exemplary embodiment of the present invention.

FIG. 2 is a flowchart illustrating a method for automatically recommending an application using AR data according to an exemplary embodiment of the present invention.

FIG. 3 is a flowchart illustrating a method for recognizing an object according to an exemplary embodiment of the present invention.

FIG. 4 is a flowchart illustrating a method for analyzing an object according to an exemplary embodiment of the present invention.

FIG. 5 is a flowchart illustrating a method for searching for an application according to an exemplary embodiment of the present invention.

FIG. 6 is a flowchart illustrating a method for processing data according to an exemplary embodiment of the present invention.

FIG. 7 is a diagram illustrating a method for executing a display of an application having tag information loaded thereon according to an exemplary embodiment of the present invention.

FIG. 8 is a flowchart illustrating a method for outputting data according to an exemplary embodiment of the present invention.

FIG. 9 is a diagram illustrating an example of determining placement of icons according to an exemplary embodiment of the present invention.

FIG. 10, FIG. 11 and FIG. 12 illustrate an example of a display according to exemplary embodiment of the present invention.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, examples of devices are provided that can analyze Augmented Reality (AR) information related to a reference object and recommend an application using the analyzed AR information. In addition, the analyzed information is automatically applied to the recommended application and executed when the application is executed. The concepts in this disclosure are applicable to all types of devices capable of recognizing an object on the real word and displaying AR data, for example, a personal computer including a desk top computer and a note book computer, in addition to a mobile communication terminal including a Personal digital assistant (PDA), a Smart Phone and a navigation terminal. The following descriptions will be made on the assumption that the present invention is implemented on a communication system in which an AR providing terminal apparatus (hereinafter, referred to ‘terminal’) and an AR providing server apparatus (hereinafter, referred to as ‘server’) are connected through a communication network. However, aspects of this disclosure are not limited thereto. That is, the exemplary embodiments may be implemented on a hardware apparatus achieved through communication between the terminal and the server.

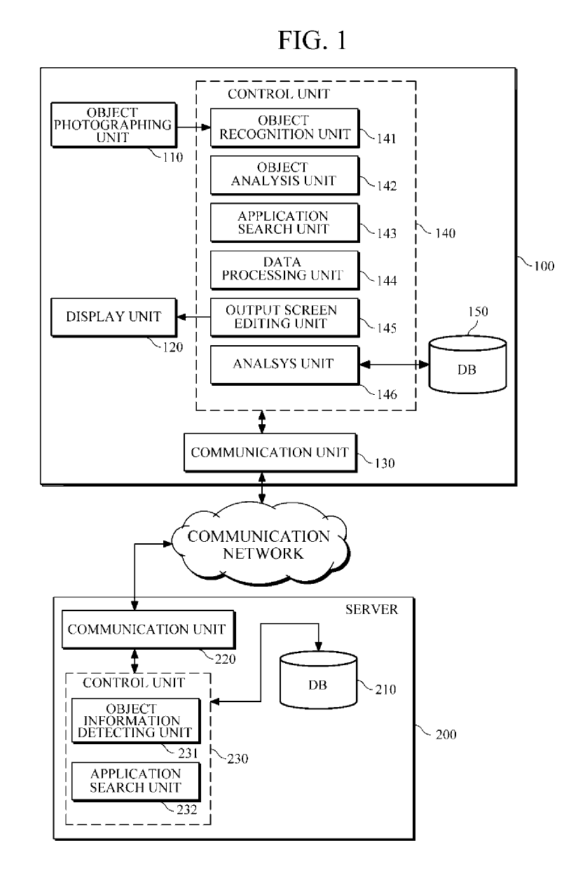

FIG. 1 is a diagram illustrating a terminal and a server according to an exemplary embodiment of the present invention.

Referring to FIG. 1, a communication system includes an AR providing terminal apparatus (hereinafter, referred to as ‘terminal’) 100, connected to an AR providing server apparatus (hereinafter, referred to as ‘server’) 200 which provides the terminal 100 with information and an application for AR service, through a wired/wireless communication network.

The terminal 100 includes an object photographing unit 110, a display unit 120, a communication unit 130, a control unit 140 and a database 150.

The object photographing unit 110 acquires information about an image of an object and outputs the acquired information. The object represents an object of interest, such as an object in a picture taken from a camera. The object may be obtained from other sources, such as a file of an image.

The display unit 120 outputs and/or displays an application using AR data. The AR data may be input from the control unit 140. The AR data represents data that is associated with recognition of the object. The AR data may be obtained by combining the object with a virtual object, or obtained using the virtual object. An application is capable of using AR data that is displayed.

The communication unit 130 processes signals that are received and transmitted through a wired/wireless communication network. The communication unit 130 receives tag information related to the object from the server 200, processes the received tag information and outputs the processed tag information to the control unit 140. The communication unit 130 processes object recognition information received from the control unit 120 and outputs the processed object recognition information to the server 200.

The control unit 140 controls components of the terminal 100 and determines an application capable of using AR data.

The control unit 140 includes an object recognition unit 141, an object analysis unit 142, an application search unit 143, a data processing unit 144, an output screen editing unit 145 and an application permission analysis unit 146.

The object recognition unit 141 recognizes an object based on photographed information acquired by the object photographing unit 110. In this example, an object photographing unit 110 may be a camera; however, aspects of the disclosure are not limited thereto, and any image acquisition devices or techniques may be utilized. The object recognition unit 141 recognizes the object by communicating with the database 210, which may be included in the server 200.

The object analysis unit 142 acquires tag information that is related to the recognized object from the server 200 and extracts search elements used for determining an application. A table is provided to represent these search elements mapped to various tag information, and this information may be stored in the database 150.

The application search unit 143 searches for an application containing permission information, the permission information being related to the extracted search element.

The data processing unit 144 generates data to determine the execution feasibility of an application, the data also being used to execute the application, before the searched application is displayed. This allows a user to execute an application with just one operation. Thus, the data processing unit 144 processes application data to allow information related to the extracted search element to be applied to an application, and allows this data to be used while the application is executed.

The output display editing unit 145 classifies the data, which is generated by the data processing unit 144, by categories so that the data is displayed on the display unit 120 in a form easily recognized by a user. Based on the placement of various UI elements and applications, and the maximum number of applications displayable, the output screen editing unit 145 may generate folders according to a criteria set by a user, so that the applications are displayable in the form that may be easier and more convenient for a user.

The application permission analysis unit 146 analyzes permissions of the applications, extracts read tag information, stores a list of the applications according to a user specified criteria in the database 150, and stores applications to be output on the display unit 120 by categories.

The database 150 may store information associated with the installed applications, an application classification criteria table and an application permission classification criteria table.

The server 200 includes the database 210, the communication unit 220 and the control unit 230.

The database 210 may store AR tag information associated with images of various objects. In recent years, content providers have promoted their products or events by including information of an object delivered to users through a terminal. The object may be physical item, such as, a movie poster, shoes and a mobile phone, or non-physical matters that can be recognized on a display of the terminal through AR, for example, Bar/QR code. The content provider stores tag information in the database 210 so that a user may view information associated with an object based on delivery via an application.

The communication unit 220 receives and transmits various data and information through a communication network, such as, a wired, wireless, or the like. The communication unit 220 receives an image of an object transmitted from the terminal 100, processes the received image, outputs the processed image to the control unit 230, detects tag information related to the object from the image and transmits the detected tag information to the terminal 100.

The control unit 230 includes an object information detecting unit 231 and an application search unit 232. The object information detecting unit 231 detects tag information corresponding to the object, which is photographed by the terminal 100, from the database 200 and outputs the detected tag information.

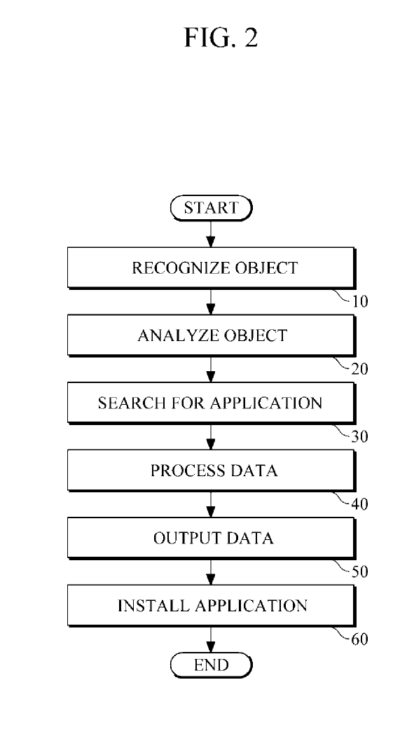

FIG. 2 is a flowchart illustrating a method for automatically recommending an application using AR data according to an exemplary embodiment of the present invention.

Referring to FIG. 2, a method for automatically recommending an application by using AR data is disclosed. An object is recognized (10). As stated above, the object may be sourced from an image taken from a camera or another image acquisition device. Once the object is recognized, tag information related to the recognized object is analyzed to extract search elements to determine an application (20). A database performing this analysis may store information about the tags associated with the object, or alternatively, the tags may be provided from another source. Once search elements are extracted, these search elements are used to determine at least one application containing permission information, with the application being associated with AR data (30). The permission information may be related to the extracted search element. The found application is output (50). Thus, the application may be executed, used or processed by an external or local device. After the application is determined by operations 10, 20, 30 and 50, the application may further include processing application data based on the found application (40) and installing the output application, such as a device configured to use the application (60).

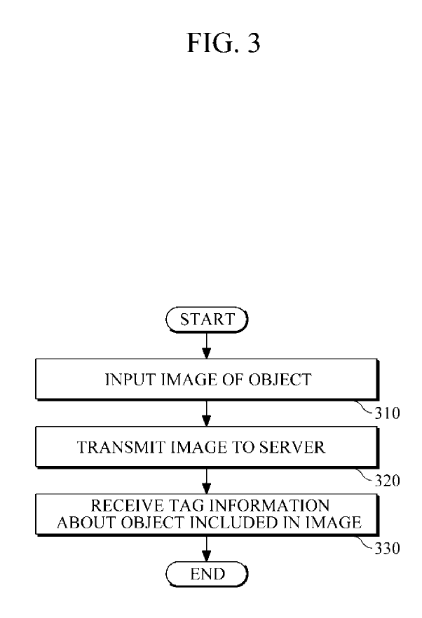

FIG. 3 is a flowchart illustrating a method for recognizing an object according to an exemplary embodiment of the present invention.

Referring to FIG. 3, as an image of an object is input from the object photographing unit 110 to the object recognition unit 141 of the control unit 140 (310), the object recognition unit 141 sends the server 200 the image (320). The server 200 detects tag information related to the object included in the image, and transmits the detected tag information to the terminal 100. As stated above, the tag information associated with the object may be stored in a database or extracted through any other technique known to one of ordinary skill in the art. The tag information may pertain to information associated with the object. The tag information may be combined in another operation with an object of a real-world image, thereby producing AR data. The object recognition unit 141 receives the tag information related to the object included in the image from the server 200.

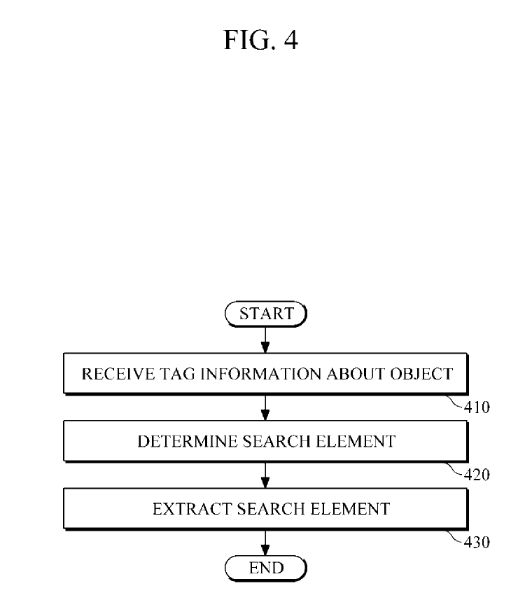

FIG. 4 is a flowchart illustrating a method for analyzing an object according to an exemplary embodiment of the present invention.

As shown in FIG. 4, the object analysis unit 142 of the control unit 140 receives the tag information related to the object from the object recognition unit 141 (410). The object analysis unit 142 determines a search element used to determine an application from the tag information (420) and extracts this search element (430). The search element may be used to determine an application for installation, execution or the like.

The object analysis unit 142 determines the search element by referring to an application classification criteria table shown as table 1.

TABLE 1

| Search Elements | Tag information |
|---|---|
| GPS | (1) 592, NonHyun-dong, NamDong-gu, Inchon-si |
| | (2) DMC SangAm-dong, Mapo-gu, Seoul-si |
| | (3) Deoksugung, Children Park, Jeju island |
| Tel Number | (1) 010-1111-1111 |
| | (2) 02-111-1111 |
| IP address | (1) www.URL.com |
| | (2) 192.168.1.1 |
| The others | QR/Bar Code |
| (QR/Bar code) | |

For example, in a case in which a watch is recognized as the object, and the content provider provides the address of a store and the phone number of the content provider as tag information about the object:

15th floor, Daerung Post Tower (The second complex) 182-13, Guro-dong, Guro-gu, Seoul-si, zip code: 152-051;

Tel: 1599-0110/Fax: 02-849-4962/E-mail: customerservice@11st.co.kr.

The object analysis unit 142 acquires the above tag information (such as the address and telephone number above). The object analysis unit 142 analyzes the tag information and if information is determined to be an address. This analysis may be accomplished using a technique that parses the tag information and searches for common words associated with an address. For example, the object analysis unit 142 may determine the tag information is an address by determining if the tag information ends with the text of ‘si’ (city), ‘gu’ (street) or ‘dong’ (neighborhood). Thus, if the tag information is determined to be an address, the search element used to determine an application may be a location providing application (such as a Global Positioning system, GPS).

In another example, the object analysis unit 142 may determine that the tag information pertains to a telephone number if a series of four digits are repeated twice in the tag information or eleven digits representing a general mobile phone number are recognized. Thus, as described above, the search element used for determining an application may pertain to a ‘telephone program’ or the like.

Similarly, if a web address such as http://www.URL.com is acquired from the tag information, through parsing the tag information for common attributes of a URL, the object analysis unit 142 may determine that the search element used to determine an application to be ‘web browser’ or the like.

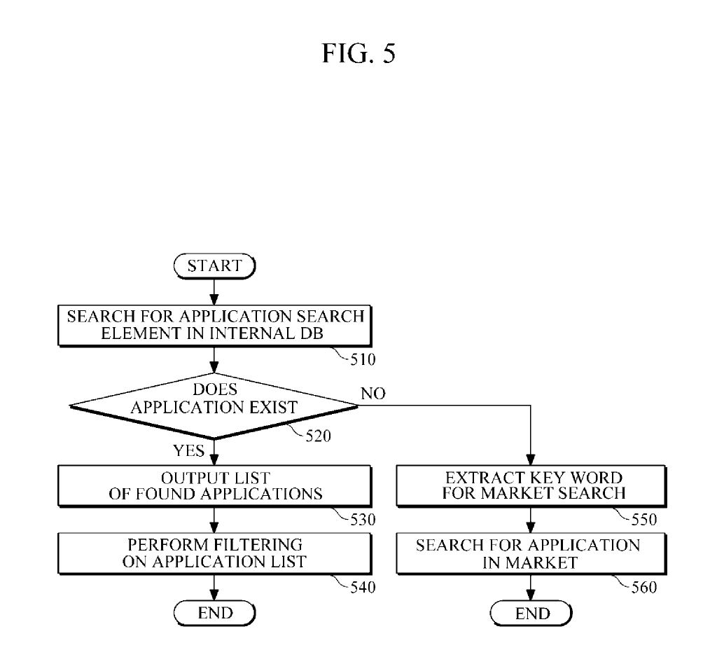

FIG. 5 is a flowchart illustrating a method for searching for an application according to an exemplary embodiment of the present invention.

The control unit 140 extracts a list of applications based on the search element that is extracted by the object analysis unit 142. This list of applications and/or the application may provide a user with a greater understand of the object sourced from a captured or provided image.

Referring to FIG. 5, the application search unit 143 searches for a search element used to determine an application (or applications) in the DB 150 (510).

The application search unit 143 determines whether an application corresponding to the found application search element exists or is stored in the DB 150 (520). As described above, the permission information of the applications installed in the terminal 100 is analyzed, and correlated with the applications stored in the database 150 to provide a classification list based on existing applications in the DB 150 that are allowed to be executed on a terminal 100 based on permission information. The application search unit 143 extracts at least one of the applications by automatically choosing the most appropriate application or allowing a user to select an application from the list. For example, the application search unit 143 uses permission information related to the search element, and searches for an application based on the correlation. A table that correlates the search element and permission information is shown in table 2.

TABLE 2

| Search Element | Permission Information |
|---|---|
| GPS | android.permission.ACCCESS_FINE_LOCATION |
| | android.permission.ACCCESS_NETWORK_STATE |
| | android.permission.ACCCESS_COARSE_LOCATION |
| Tel Number | android.permission.CALL_PHONE |
| | android.permission.SEND_SNS |
| IP address | android.permission.INTERNET |
| | android.permission.ACCCESS_NETWORK_STATE |
| SNS | android.permission.INTERNET |
| | android.permission.ACCCESS_NETWORK_STATE |
| | android.permission.VIBRATE |
| | android.permission.READ_CONTANCTS |
| The Others | android.permission.CAMERA |
| (QR/Bar Code) | android.permission.INTERNET |

If a result of operation 520 is that an application corresponding to the search element exists in the database 150, and terminal 100 may operate and/or execute the application based on its analyzed permission list, the application search unit 143 outputs an application list having the found application or applications (530).

The application search unit 143 filters the applications included in the application list based on priorities (540). For example, if the tag information contains elements found in an address, the search element used to determine an application may be ‘position based’, ‘GPS’ or the like. If a series of four digits is repeated twice in the tag information, the search element may be related to a telephone number. If a web address such as http://www.URL.com is acquired from the tag information; the application search element may pertain to a web browser or the like. In this case, the application search unit 143 may filter an application or applications that match all, or some of, of the search elements extracted. The application search unit 143 may also filter an application or applications that are matched to some of the application search elements.

Therefore, once a search term is ascertained, the permissions associated with the search term (using table 2) may be correlated. Thus, the most appropriate search term may be determined by comparing the associated permission information with the permission information associated with applications of the terminal 100.

If a result of operation 520 is that an application list corresponding to the extracted application search element is null or no applications are found in the database 150, the application search unit 143 may determine a search element by re-analyzing the tag information with the use of a market keyword from a market search keyword table, as shown below (550). Specifically, the extracted search term may access an alternate or additional database of applications, such as an online market application or the like, and provide a list of applications from that source.

TABLE 3

| Market | | |
|---|---|---|
| Keyword | Tag Information | Keyword |
| GPS | (1) Nonhyun-dong, | (1) Location Information |
| | Namdong-gu, Inchon-si | |
| | (2) Woongung-ri, | (2) DMC traffic information |
| | Tongin-myun, Kimpo-si | |
| | (3) Deoksugung, | (3)Tour site recommendation, |
| | Children Park, Jeju | Tourist attractions |
| | island | |
| Tel Numbers | (1) 010-1111-1111 | Call, phone number |
| | (2) 02-111-1111 | |
| IP address | | Web search, Google search, |
| | | Naver search |
| SNS | Key word of Tag | |
| | information | |
| The others | QR/Bar code | QR/Bar code reader |
| (QR/Bar code) | | |

For example, if tag information is Deoksugung, ‘tour site recommendation’ or ‘tourist attractions’ may be selected as a keyword. The application search unit 143 performs a market search by use of the found key word (560). If the application is output in operation 50 of FIG. 2, a shortcut icon may be generated and output so that a recommendable application is searched based on the market keyword. Thus, the user may access the shortcut icon to be taken to the market database, and thereby purchase and/or obtain the application found from the market source.

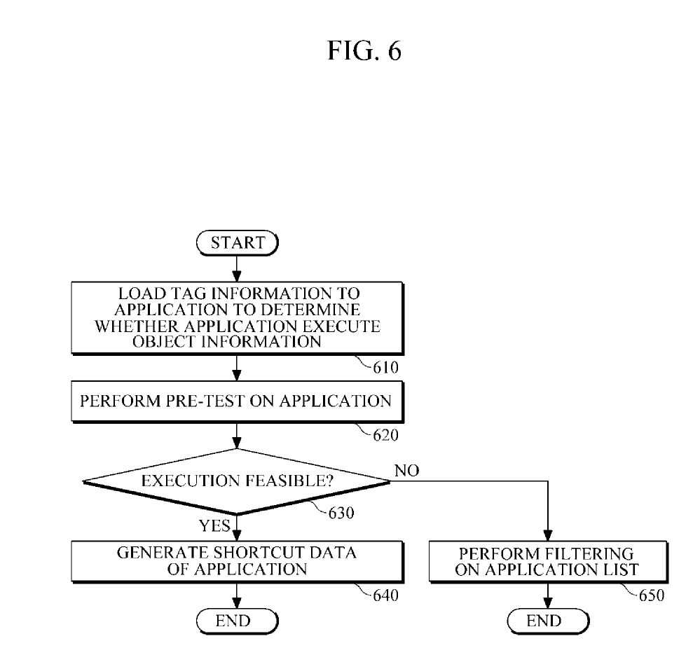

FIG. 6 is a flowchart illustrating a method for processing data according to an exemplary embodiment of the present invention.

The data processing unit 144 of the control unit 140 loads respective tag information to applications found by the application search unit 143 and to an application list found in a market (610). For example, in order to execute a web search application, which executes IP address ‘www.sanghyeok.com’, the address ‘www.sanghyeok.com’ is loaded in a web search application, and/or a shortcut link to the execution of the address is provided. All of this is accomplished after an object is recognized, and therefore the internet address is loaded automatically and in one step. Alternatively, an application pre-test may be performed (620).

The data processing unit 144 determines whether an application is executable and allowable (such as containing the correct permission information or able to be handled by terminal 100) through a result of the application pre-test (630). If a result of operation 630 is that an application is executable and allowable, the data processing unit 144 generates a shortcut data for the application (640). Application data is processed such that information related to the extracted search element is applied to the application, if the application is executed. That is, the shortcut data for the application is processed and used to generate an icon, and the generated icon is provided to a user.

If a result of operation 640 is that an application is neither executable and/or allowable, for example, the application does not execute on terminal 100, the extracted tag information may not be used with the application, the data processing unit 144 filters out the application from the application list.

For example, if a result related to tag information ‘Deoksugung’ determines that an application that provides information about ‘Date Attractions’ is appropriate, and applications relating to ‘Date Attractions’ are not executable or allowable based on permission information, the application is not output and delivered, while the tag information ‘Deoksugung’ is directly output. In this case, only the tag information is provided, independent of the search term of the application.

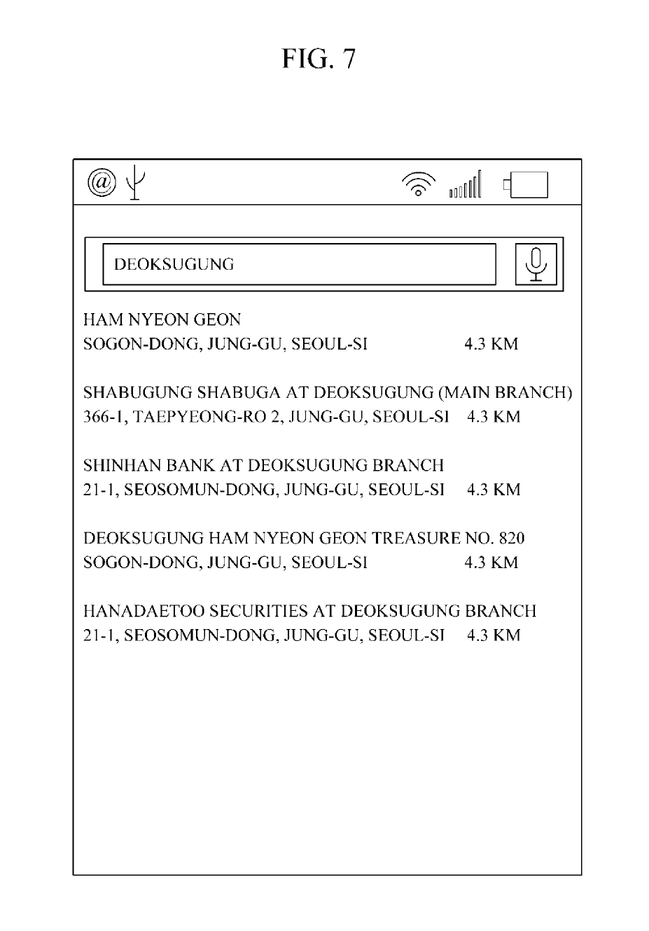

FIG. 7 is a diagram illustrating a method for executing a display of an application having tag information loaded thereon according to an exemplary embodiment of the present invention.

Referring to FIG. 7, and contrary to the previous example, an application ‘Date Attractions’ is executed, a search result related to the tag information ‘Deoksugung’ is output. As shown in FIG. 7, various locations pertaining to ‘Deoksugung’, related to the search term ‘Date Attractions’ are provided. Thus, the list of locations, and the distance from Deoksugung are provided in the display.

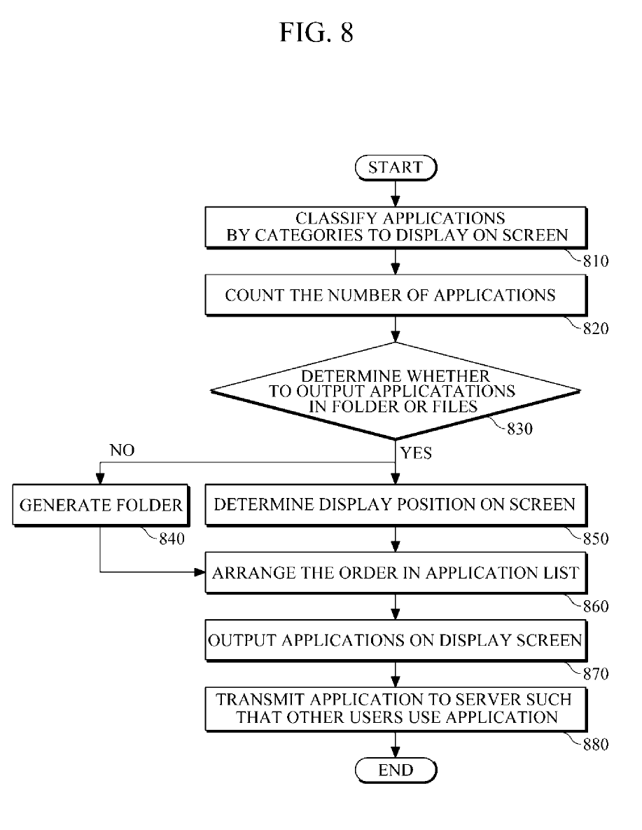

FIG. 8 is a flowchart illustrating a method for outputting data according to an exemplary embodiment of the present invention.

Referring to FIG. 8, the output screen editing unit 145 outputs the application that has been determined based on the extracted search term to the display unit 120. As explained above, the determination of this application may undergo a pre-filtering stage to determine if the application is executable and allowable to be performed on the terminal 100. In order to output data in a readable form, which may look cluttered due to the linking of tag information with an application (and the display thereof), the output screen editing unit 145 may classify and organize the display of the applications by categories (810).

The criteria for dividing the categories of applications may be downloaded or may be determined based on usage tendency. For example, applications may be organized into categories with each other based on having a similar usage rate. Other techniques to categorize and/or classify the applications may also be implemented. The applications may be divided into categories that include education, traffic, weather, news, magazines, tools, life style, media, video, business, shopping, sports, entertainment, travel, local information, social networking sites, social information, and the like. The list of categories is not limited to the categories enumerated above.

In order to determine whether to display all of the classified applications on the display or display the classified applications in folders, the output screen editing unit 145 may count the applications (820).

The output screen editing unit 145 determines whether the applications are to be output in folders or files (830). Thus, if after counting the applications, a determination is made that the number of applications exceeds the maximum number of applications set, the applications may be displayed as folders. For example, if the maximum number is 14, three files may be disposed above an object, three files may be disposed below an object, four files may be disposed on the right of the object and four files may be disposed on the left of the object, thus being 14 or under and satisfying the condition. If the number of applications to be output exceeds fourteen, the applications are classified in folders and output in folders. If the number of desired applications is below fourteen, the applications are output as icons. Similar to the position of the files, the position of the folders may be also disposed at the upper position on the display containing three folders, the lower position on the display containing three folders, the right position on the display containing four folders and the left position on the display containing four folders. An application not having been classified into any folder is put into a folder that may store one or more non-categorized applications. Based on the example above, the applications may be displayed in a manner that does not appear cluttered on the display and utilizes all the area around an object in an efficient manner.

That is, if a result of operation 830 is that applications are to be output in folders, the output screen editing unit 145 generates folders (840). If a result of operation 830 is that applications are to be output as icons, the output screen editing unit 145 determines a display position on the display (850) for displaying the various icons. For example, the output screen editing unit 145 may give each position on the display a sequence number depending on a priority.

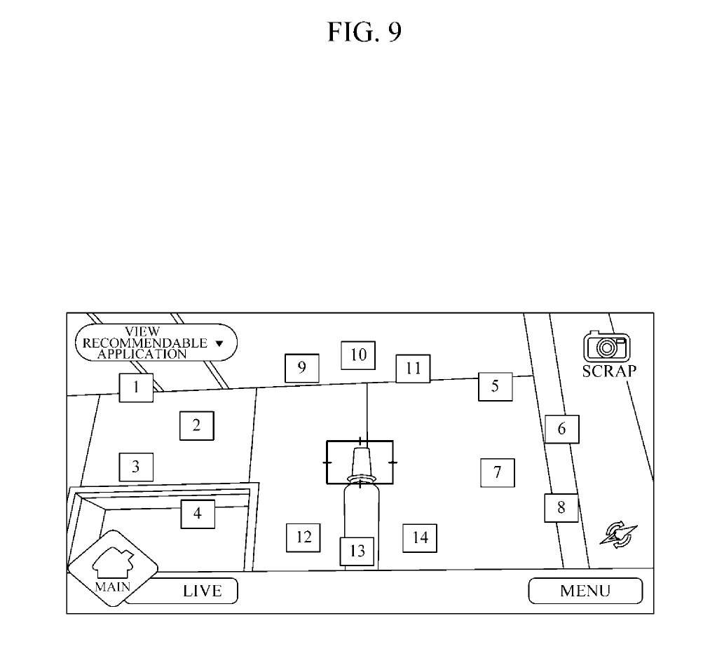

FIG. 9 is a diagram illustrating an example of determining placement of icons according to an exemplary embodiment of the present invention.

Referring to FIG. 9, an upper left position of a display, which may be easily accessible by a user, is given a sequence number ‘1’ and positions below the upper left position are given sequence numbers ‘2’, ‘3’ and ‘4’. An upper right position of the display is given a sequence number ‘5’ and positions below the upper right position are given sequence numbers ‘6’, ‘7’ and ‘8’. Sequence numbers ‘9’, ‘10’ and ‘11’ are given to positions, starting from the left to the right on the remaining upper part of the display. Finally, sequence numbers ‘12’, ‘13’ and ‘14’ are given to positions, starting from the left to the right on the lower part of the display. Thus, the 14 positions allow for an efficient and maximum usage of all the space around an object, thereby prevent clutter of all the provided applications on spot near the object.

Thereafter, the output screen editing unit 145 arranges the order in application list in different categories (860).

That is, the output screen editing unit 145 determines the order of priorities for applications that are to be displayed on the display. An application being executable and allowable (and thus being permitted to be operated on by terminal 100), and is matched to the largest number of application search elements of tag information, may have the highest priority. For example, if four application search elements are found from tag information, an application having the correct permissions for all of the four search elements is given the highest priority. If the order of priority of applications is not able to be determined based on the number of the matching application search elements, the order of priority of applications may be determined based on the frequency of searching for the applications with respect to an object and stored in the server 200. Thus, a usage list may be kept, and may be stored in a recommendable application database 212 of the server 200, and an application, which is the most frequently used by users, is given a highest (or higher) priority among the applications.

If the order of priority of applications is not determined based on the frequency of searching, a user may give the highest priority to an application that is the most frequently executed among installed applications. If the order of priority of applications is not determined based on the frequency of execution, a user may determine the order of priorities of applications based on the correlation of the categories. If the order of priorities of applications is not given based on the correlation of the categories, the most recently installed application is given a higher priority.

After the order of in the application list has been arranged, the output screen editing unit 145 displays applications according to the order of priorities (870). The output screen editing unit 145 transmits a list of applications recommended in this manner, to the recommendable application database 212 of the server 200, so that other user may use the application list as recommendation information for determining an application to be executed that is associated with the object (880). The output screen editing unit 145 displays at least one application as an icon.

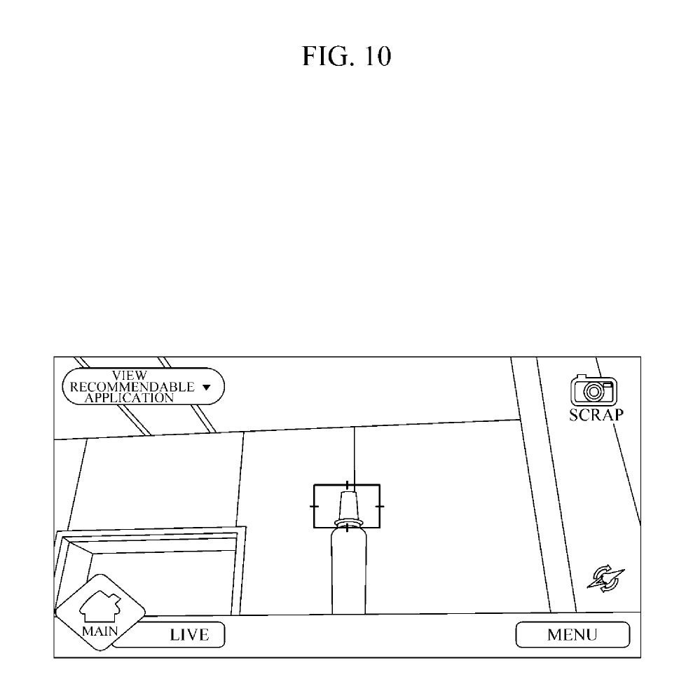

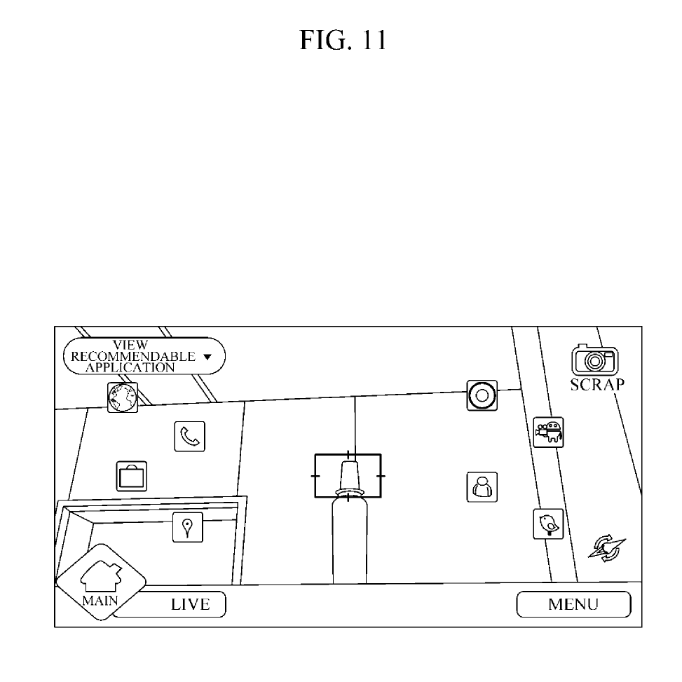

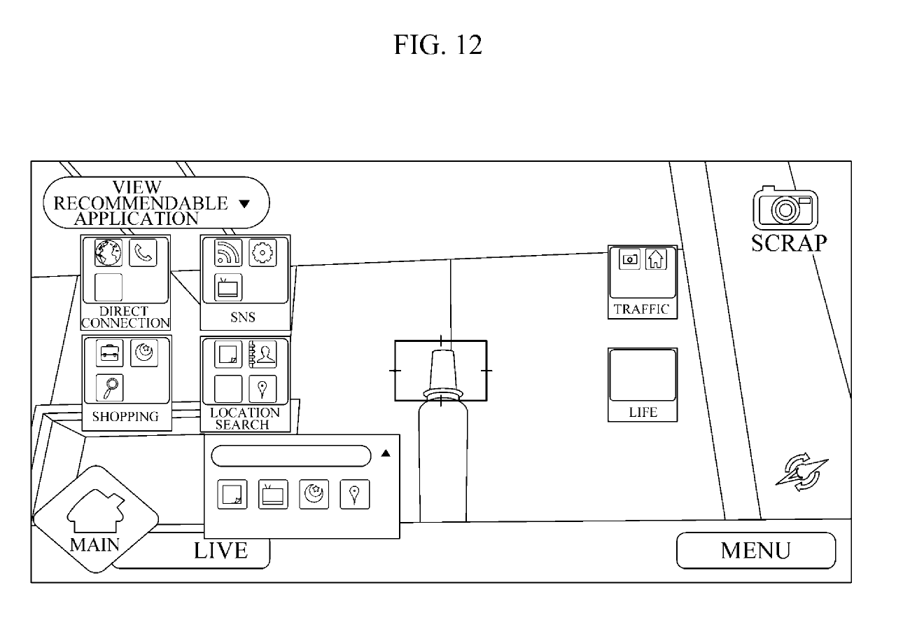

Hereinafter, the above example is described with reference to FIG. 10, FIG. 11, and FIG. 12. FIG. 10, FIG. 11 and FIG. 12 illustrate an example of a display according to an exemplary embodiment of the present invention.

Referring to FIG. 10, without showing any icons that are shortcuts to applications, a button ‘view recommendable applications’ is generated on the upper left side of the display. Referring to FIG. 11, if a user clicks the button to ‘view recommendable applications’, icons for recommended applications are displayed (which may incorporate the output methodology described above utilizing priority determination). If a recommended application corresponding to desired information exists on the display, the user may click an icon corresponding to the recommended application to obtain the desired information. If the number of recommended applications exceeds a maximum number that can be displayed on a display, folders of different classifications are generated and disposed on the display, as shown in FIG. 12. If a user clicks a desired folder, a sub-folder is generated below the folder and an execution icon (or icons) that execute an application (or applications) is output.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
an image acquisition unit to acquire an image of a real-world environment;
an object recognition unit to recognize an object from the image;
an object analysis unit to analyze tag information associated with the object;
a search term generating unit to determine a search term based on the tag information,
wherein the search term is utilized to determine an application for the mobile terminal, and
the application utilizes the tag information in response to the application being executed.

2. The terminal according to claim 1, further comprising:
a permission analysis unit to determine permission information associated with installed applications of the mobile terminal,
wherein the permission information is also utilized to determine the application for the mobile terminal.

3. The terminal according to claim 2, wherein if multiple applications are determined based on the search term, the applications are prioritized based on a level of correlation between the permission information the installed applications of the mobile terminal and permission information associated with each application.

4. The terminal according to claim 1, wherein the application is a shortcut link that searches an application database.

5. The terminal according to claim 4, wherein the shortcut link is provided if no application is determined based on the search term.

6. The terminal according to claim 1, further comprising a display unit to display at least one of the object, the tag information and an icon for the application.

7. The terminal according to claim 6, wherein if more than one application is determined, and the display unit prioritizes icons for the applications and places the icons around the object based on the priority of each icon.

8. The terminal according to claim 7, wherein if a number of the icons exceed a threshold, the icons are organized via categories, and the display unit displays a folder for each category.

9. The terminal according to claim 1, further comprising:
a communication unit to communicate the search term to a server,
wherein the communication unit receives the application from the server.

10. A method for providing an application based on augmented reality, comprising:
acquiring an image of a real-world environment;
recognizing an object from the image;
analyzing tag information associated with the object;
determining a search term based on the tag information;
determining the application for the mobile terminal based on the search term; and
utilizing the tag information in response to the application being executed.

11. The method according to claim 10, further comprising:
determining permission information associated with installed applications of the mobile terminal;
additionally determining the application for the mobile terminal based on the permission information.

12. The method according to claim 11, wherein if multiple applications are determined based on the search term, prioritizing the applications based on a correlation level between the permission information of the installed applications of the mobile terminal and permission information associated with each application.

13. The method according to claim 10, wherein the application is a shortcut link that searches an application database.

14. The method according to claim 13, wherein the shortcut link is provided if no application is determined based on the search term.

15. The method according to claim 10, further comprising:
displaying at least one of the object, the tag information and an icon for the application.

16. The method according to claim 15, wherein if more than one application is determined, prioritizing icons for the applications and placing the icons around the object based on the priority of each icon.

17. The method according to claim 16, wherein if a number of the icons exceed a threshold, organizing the icons via categories, and displaying a folder for each category.

18. The method according to claim 10, further comprising:
communicating the search term to a server; and
receiving the application from the server.

19. A server to provide an application based on augmented reality, comprising:
a communication unit to receive augmented reality data and transmit the application to an external device; and
an application search unit to determine the application based on the augmented reality data.

20. The server according to claim 19, further comprising:
an object recognition unit to recognize a search term based on the augmented reality data,
wherein the application search unit determines the application based on the search term.
